(19) United States
(12) Patent Application Publication
(10) Pub. No.: US 2012/0151604 A1
(43) Pub. Date: Jun. 14, 2012

(54) SEEDING OF ACCOUNT SETUP OPERATIONS

(75) Inventors: Edwin Thorne, III, Seattle, WA (US); Francie Zant, Seattle, WA (US); Michael Patten, Sammamish, WA (US); Brent Dietrich, Seattle, WA (US); Scott Porter, Sammamish, WA (US)

(73) Assignee: MICROSOFT CORPORATION, Redmond, WA (US)

(21) Appl. No.: 12/964,650

(22) Filed: Dec. 9, 2010

(51) Int. Cl. G06F 21/00

(52) U.S. Cl. 726/28

(57) ABSTRACT

A system and method and provided for setting up target user accounts based on the accounts or experiences of other users or archetypes. One example method first includes determining that a first user wants to set up or modify an account for the consumption of digital content items. Then an account profile is identified for a second user that has an affinity with the first user, with the account profile being based on an account of the second user. Underlying protected information in the source account/profile is then protected to ensure that the account profile is free of sensitive or otherwise protected information. The account profile is then made available and used to set up or modify an account for the target user.

### BACKGROUND

Online user accounts are now a fact of everyday life. The typical Internet user must manage 20, 30 or perhaps more user accounts, each of which entails a varying array of password/authentication methods, user-selectable settings and options, favorites lists, payment information and the like. The mental overhead associated with establishing a new user account is often enough to dissuade a user from proceeding, even where the eventual account would have provided a rewarding consumption experience.

### SUMMARY

Accordingly, the disclosure provides for a system and method for setting up user accounts based on the accounts or experiences of other users or archetypes, which will be referred to in some respects as a process by which the new or modified accounts are “seeded” using information from other accounts. One example method includes determining that a first user wants to set up or modify an account for the consumption of digital content items. Then an account profile is identified which is associated with a second user that has an affinity with the first user, with the account profile being based on an account of the second user. Underlying protected information in the source account/profile is then protected to ensure that the account profile is safe to share without compromising security. The account profile is then made available and used to set up or modify an account for the target user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts an exemplary scenario in which an account is set up for a target user based on an account profile derived from the account of a second user, sometimes referred to as the source user.

FIG. 2 depicts an exemplary computing system with executable instructions for establishing and configuring new user accounts based on account profiles derived from existing user or archetype user accounts.

FIG. 3 depicts an exemplary method for configuring user accounts.

### DETAILED DESCRIPTION

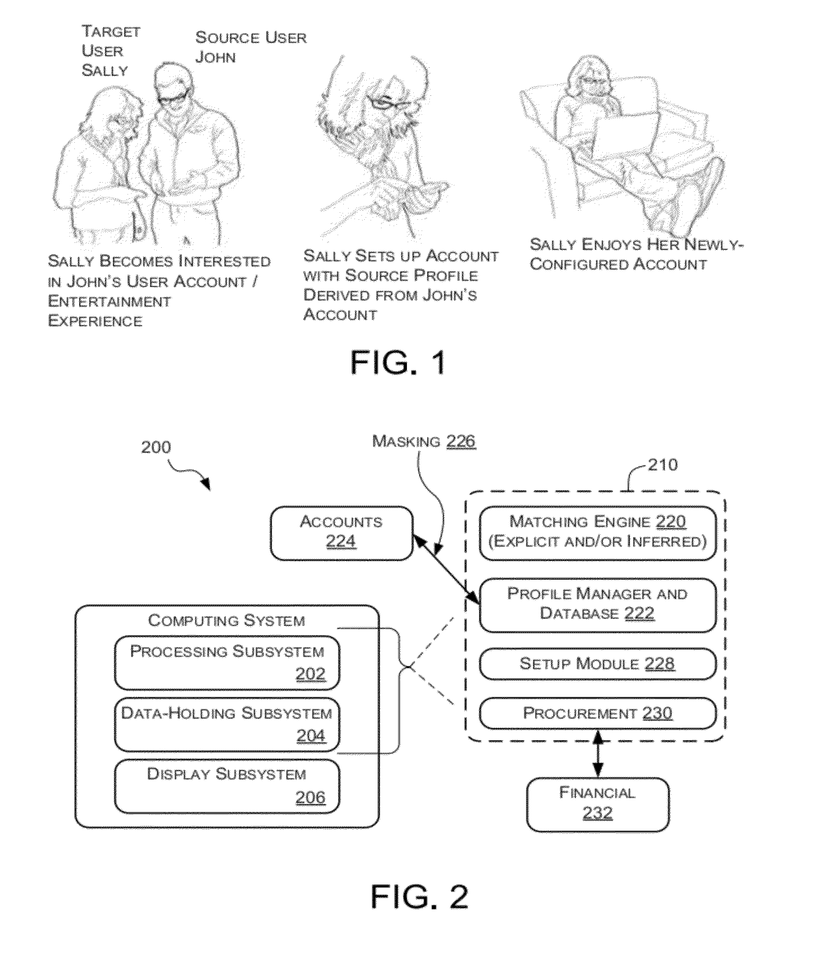

FIG. 1 first provides an example scenario in which one user sets up or modifies a user account based on or seeded with information from the account of another. In particular, target user “Sally” is shown speaking with source user “John.” Sally may be observing one of John's “favorites” lists, listening to a song or seeing one of his TV shows, etc. As a result of observing the account itself and/or the consumption experience it provides, Sally is interested in having a similar entertainment experience. Whether or not she conceives of setting up a new account as the actual task needed to achieve this, her desire is ultimately used to identify a source account profile that is used to set up the new target account. The middle portion of FIG. 1 shows Sally after the interaction, at a point where she is walking through a simple-to-use setup procedure in which she is offered to opt-in to some or all aspects of an account profile that has been generated from John's account. Then, on the far right, Sally is shown enjoying her new consumption experience, and she has achieved that benefit at a fraction of the effort that would have been involved in setting up an account from scratch with no assistance.

FIG. 2 shows at 200 a system for configuring a user account through intelligent leveraging of an account profile built from user or archetype user accounts. The process begins with a desire, which can be inferred or explicit, that a target user wishes to have a new and different consumption experience (e.g., on the Internet). Typically, this involves setting up or modifying a user account which, as previously mentioned, can be an obstacle in terms of the time and mental overhead associated with account setup.

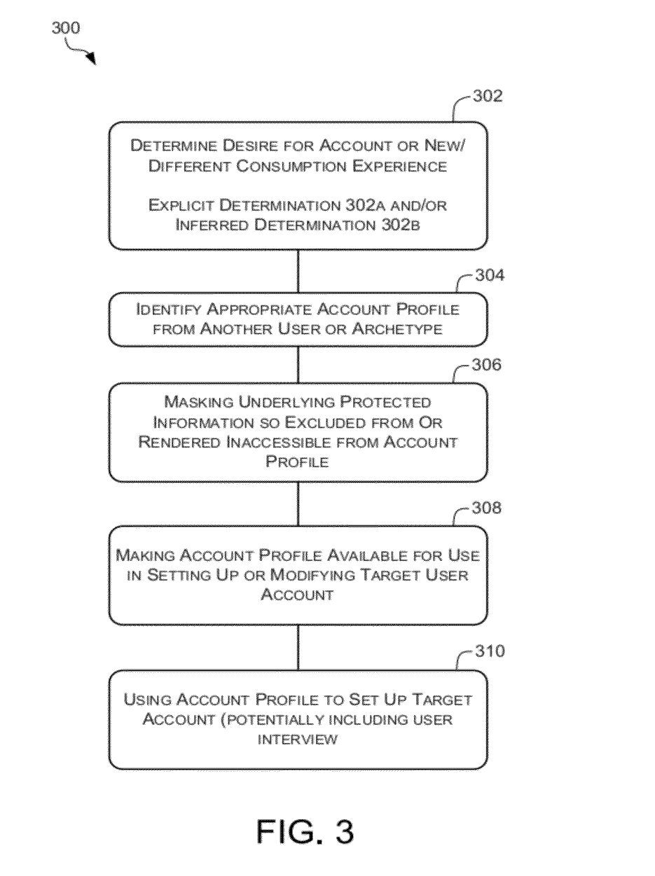

In a first example, the desire for a new/modified account or consumption experience is explicitly asserted by the user, as shown at 302a of the exemplary method shown at 300 in FIG. 3. The desire is registered, for example at matching engine 220, so that an appropriate account profile can be retrieved. Matching engine 220 is included in and instantiated by executable instructions 210, which may be held in data-holding subsystem 204 and executed by processing subsystem 202 of the depicted exemplary computing system. Execution of these instructions as described herein will result in a particularized machine that transforms the visual display subsystem 206, through varied and changing display output.

The explicit desire indicated by the user at step 302 in FIG. 3 may simply be an affirmative request to have an account set up which is similar in some respects to the account of a friend, coworker, etc., whether or not that desire is expressed specifically in terms of having a similar account or a similar listening/reading; experience. The exposure to the second user may be relatively direct (in-person conversation, telephone call, etc.) or mediated through social networks such as a social networking site or other mechanisms. Accordingly, in one example, an explicit desire is generated in response to interaction of a user with a social networking site.

In a second example, interest is inferred as shown at 302b. Inferences may be based on past or current consumption behavior, on social network activity, on expressions of preferences or tastes, or through collaborative filtering or other appropriate techniques. For example, an inferred best profile match may be based on an inference drawn from asking a user targeted questions and/or asking a user to rate specific content. These are but examples, appropriate inferences may be achieved through a wide range of techniques.

Regardless, the method 300 may then proceed to identification of an appropriate account profile, as shown at 304. The identified profile in many cases is associated with an underlying account of an actual user (e.g., friend, coworker, etc.). In other examples, a profile associated with an archetype may be employed—e.g., “Hip-Hop Fan,” “French Cinema Buff,” etc., with the interests, preferences, settings and other features one might expect to be associated with such a user. To identify a suitable actual or archetype profile, the user may also be polled to assess their preferences or other information that can be used in identifying a suitable account profile.

In either case, the profile may be housed and managed within a profile manager database 222 which interacts with accounts 224 (or copies thereof) to generate the profiles. It should be understood here and with respect to the rest of this disclosure that various modules, components and the like may be described as being discrete (e.g., database 222) but which can easily be distributed and/or spanned across multiple physical or logical locations. The discussion should be understood to encompass all desirable and practicable implementations, whether distributed, discrete or otherwise.

In some cases, generating profiles may include a masking function 226 (306 in FIG. 3) in which underlying protected information is masked from the profile to ensure that it is does not appear there, as the profile will ultimately be shared for use in establishing or modifying a user account. Such protected information may include address information or other personal details, sensitive financial information, and the like.

Furthermore, in some cases, a source user may customize or select information, portions of a profile, and/or portions of an account to be selectively masked for different users or groups of users. For example, a user may customize a profile mask setting to share a portion of their profile with a group of friends, but mask that portion of the profile from being shared with other members of a social network. It is to be understood that any suitable information, aspects, portions, user experience components, and the like related to an account or profile may be customized by an account/profile owner to be shared or masked from being shared to different users or groups of users.

The method 300 may then proceed by making the retrieved account profile available for use for the purpose of setting, up or modifying an account for the target user, as shown at 308. The presentation of the profile or the user interface via which it is shared with the target user may occur in various ways. Presentation may occur through a desktop, mobile or set-top-box (SIB) computing device, and/or be communicated through social networks or other channels. Again, these are but a few non-limiting examples.

Method 300 may then proceed at 310 with making use of the account profile to set up or modify the account of the target user. In the example of FIG. 1, setup/modification may be performed and be handled by setup module 228. In any case, during setup, the account profile of the explicitly-identified or inferred user or archetype is used to generate or modify the account of the target user. In one example, the target user is interviewed (310a) to determine what aspects of the account profile they want to opt-in for. In some cases, the options may be presented in a user-selectable template (310b) of options. In one example, options in a user selectable template correspond, at least in part, to information from a source user profile/account that has been selected as being available to be shared with the target user based on masking settings customized by the source user. More particularly, the target user and the source user share a relationship that enables information from the source user profile/account to be shared with the target user for the purpose of creating or modifying the profile/account of the target user.

Account setup or modification may also include signing up for subscriptions (310c) or other mechanisms for paying for and receiving digital content. Pointers may be established to existing digital content items, and/or a mechanism may be provided for license procurement (308d) and DRM-type management.

In addition to or instead of the other features described herein, establishing a new or modified account may include seeding an account to establish account preferences. For example, in a travel website, the methods herein may be employed to set preferred destinations or types of travel. Further, establishing or modifying an account may include using the seeding methods discussed herein to customize what the user shares with other users or groups of users.

In the example of FIG. 1, license procurement and DRM-type issues may be handled by procurement module 230. Set up for the target user may also include obtaining financial information 232 or other appropriate account information.

As indicated above with respect to FIG. 1, in some embodiments, the above described methods and processes may be tied to a computing system including one or more computers. In particular, the methods and processes described herein may be implemented as a computer application, computer service, computer API, computer library, and/or other computer program product. Various architectures and form factors may be employed in connection with the described systems and methods, including mainframe computer, server computer, desktop computer, laptop computer, tablet computer, home entertainment computer, network computing device, mobile computing device, mobile communication device, gaming device, etc.

The example computing system includes a processing subsystem, as indicated above. Processing, subsystem 202 may include one or more physical devices configured to execute one or more instructions. For example, the processing subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The processing subsystem 202 (also referred to herein as a logic subsystem) may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 204 may include one or more physical, non-transitory, devices configured to hold data and/or instructions executable by the logic subsystem to implement the herein described methods and processes. When such methods and processes are implemented, the state of data-holding subsystem may be transformed (e.g., to hold different data).

Data-holding subsystem 204 may include removable media and/or built-in devices. Data-holding subsystem 204 may include optical memory devices (e.g., CD, DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 204 may include devices with one or more of the following characteristics: volatile, nonvolatile, dynamic, static, read/write, read-only, random access, sequential access, location addressable, file addressable, and content addressable. In some embodiments, processing subsystem 202 and data-holding subsystem 204 may be integrated into one or more common devices, such as an application specific integrated circuit or a system on a chip. Removable computer-readable storage media may also form part of the data-holding subsystem.

The terms “module,” “program,” and “engine” may be used to describe an aspect of computing system 200 that is implemented to perform one or more particular functions. In some cases, such a module, program, or engine may be instantiated via processing subsystem 202 executing instructions held by data-holding subsystem 204, it is to be understood that different modules, programs, and/or engines may be instantiated from the same application, service, code block, object, library, routine, API, function, etc. Likewise, the same module, program and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from to client.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for establishing and setting up a user account for consumption of digital content items, comprising:
determining that a first user wants to set up or modify an account for the consumption of digital content items;
identifying an account profile of a second user that has an affinity with the first user, where such account profile is based on an account of the second user;
masking underlying protected information in the account of the second user so that the account profile is free of such protected information;
making the account profile available for the purpose of setting up the account of the first user;
setting up the account of the first user based on the account profile.

2. The method of claim 1, where setting up the account of the first user based on the account profile includes interviewing the first user to determine what portions of the account profile to use in setting up the account of the first user.

3. The method of claim 1, where setting up the account of the first user based on the account profile includes establishing pointers to content that has been consumed or that is owned or licensed by the second user.

4. The method of claim where determining that the first user wants to set up an account includes receiving an explicit request from the first user to set up an account.

5. The method of claim where determining that the first user wants to set up an account includes determining that the first user has an affinity to another user having an account.

6. The method of claim 1, where making the account profile available for the purpose of setting up the account of the first user includes providing a template of options that are selectable by the first user to effect the setting up step.

7. The method of claim 6, where at least one of the selectable options is an option to set up a content subscription that is similar to a content subscription of the second user.

8. The method of claim 6, where at least one of the selectable options is an option to initiate a process whereby the first user gains access to digital content items in the account of the second user.

9. The method of claim 1, where setting up the account of the first user includes offering licenses to the first user to digital content items.

10. A method for establishing and setting up a user account for the consumption of digital content items, comprising:
receiving a request from a first user to set up an account for the consumption of digital content items that is similar in profile to an account held by a second user;
receiving an account profile of the second user, said account profile being created so as to mask underlying protected information associated with the account held by the second user;
setting up the account requested by the first user using the account profile.

11. The method of claim 10, where the request is generated in response to interaction of the first user with a social networking site.

12. The method of claim 10, where setting up the account requested by the first user includes interviewing the first user to determine what portions of the account profile to use in setting up the account of the first user.

13. The method of claim 10, where setting up the account requested by the first user based on the account profile includes establishing pointers to content that has been consumed or that is owned or licensed by the second user.

14. The method of claim 10, where said masking step is performed to prevent access to financial information of the second user.

15. A computing system for setting up user accounts to enable user consumption of digital content items, comprising:
instructions stored in a data-holding subsystem and configured to be executed by a processor to:
determine that a first user of the computing system wishes to set up or modify an account for the consumption of digital content items;
receive an account profile associated with a second user or with an archetype of user, said account profile being based on and generated from an account of the second user;
mask underlying protected information in the account of the second user so that such underlying protected information is not available in or accessible from the account profile; and
set up an account requested by the first user, where such setting up step is performed using the account profile to replicate aspects of the account.

16. The system of claim 15, where setting up the account requested by the first user includes interviewing or surveying the user prior to establishing an account based on the account profile.

17. The system of claim 15, where masking underling protected information includes preventing access to financial data in the account of the second user.

18. The system, of claim 15, where setting up an account of the first user based on the account profile includes establishing pointers to and making license offers regarding digital content items in the account of the second user.

19. The system of claim 15, where determining that the first user wishes to set up an account includes receiving an explicit request from the first user to set up an account.

20. The system of claim 15, where determining that the first user wants to set up an account includes determining that the first user has an affinity to another user having an account.
